(19) United States
(12) Patent Application Publication
(10) Pub. No.: US 2008/0313121 A1
(43) Pub. Date: Dec. 18, 2008

(54) Method and System for Managing Enterprise Operations

(76) Inventor: Yi Yan, Superior, CO (US)

Correspondence Address: Jay M. Schloff;Intellipex PLLC, Suite 245, 30200 Telegraph Road, Bingham Farms, MI, 48025, US

(21) Appl. No.: 12/138,946

(22) Filed: Jun. 13, 2008

Related U.S. Application Data
(60) Provisional application No. 60/943,881, filed on Jun. 14, 2007.

(51) Int. Cl. G06N 5/02

(52) U.S. Cl. 706/47

(57) ABSTRACT

Disclosed is a method, a system and a computer program product for assisting users in managing operations in an enterprise. An input is received from a user in the enterprise. The input is associated with an exception in an operation. The exception indicates occurrence of a fault in the operation. A corresponding resolution in a case base indicates an action to resolve the exception. Furthermore, at least one case of the set of cases is displayed to the user based on searching the at least one case base, assisting the user in managing the operation by offering at least one resolution to resolve the fault. A knowledge base and management is assembled for a user to gain knowledge about the managing enterprise process environment to support resolution and decision making. A rule base and management is assembled for a user to gain resolution and decision making advice.

### CROSS-REFERENCE TO RELATED APPLICATIONS

The present invention claims priority under 35 United States Code, Section 119 on the U.S. Provisional Patent Application No. 60/943,881 filed on Jun. 14, 2007, the disclosure of which is incorporated by reference.

### FIELD OF THE INVENTION

The present invention relates generally to managing enterprise processes, and, more particularly, to managing enterprise processes based on reuse of knowledge, experience and rule.

### BACKGROUND OF THE INVENTION

An enterprise may be defined as a company organized for commercial purposes. The enterprise may include various processes such as business processes, Information Technology (IT) processes, marketing processes, sales processes, finance processes, and the like. Sometimes, exceptions may occur while performing the various processes in the enterprise. The exceptions may be defined as deviations from normal sequences that occur in the processes in the enterprise. These exceptions, if not handled and managed well, may result in a direct or an indirect impact on the enterprise.

The exceptions may be handled by users in the enterprise. A range of actions and decisions may be taken by the users in the enterprise on a regular basis for handling the exceptions. Various enterprises make use of enterprise process management systems to assist users to regulate the processes, manage the exceptions, and take decisions regarding the processes in the enterprise. An enterprise process management system may be defined as a centralized solution for all needs of the enterprise.

Presently, existing enterprise process management systems for assisting users to manage processes in the enterprise are focused on normal processes, such as business processes, IT processes, and the like. If an exception is automatically detected, a rule base may be used to launch actions to resolve the exception automatically. If the exception is not automatically detected, a support engineer needs to trouble-shoot the problem with knowledge and experience, by using a reasoning technique. The reasoning technique includes a case base. The case base is a repository of cases that provide historical data of exceptions encountered by one or more users in the enterprise and corresponding actions and/or decisions taken by the one or more users to resolve the exceptions. The reasoning technique may be utilized by the one or more users for trouble-shooting the exceptions, and, hence, enabling the one or more users to take the decisions using past experience and knowledge of the users in the enterprise.

A few existing enterprise process management systems for exception management are based on the rule base. The rule base is a repository of rules that includes pre-defined actions for the exceptions in the enterprise. The pre-defined actions may be associated with the exceptions based on analysis of the exceptions and one or more actions that may be taken to resolve the exceptions. The analysis is performed by experts. An expert is a person skilled in a process in which an exception occurs. Further, the rule base may also be maintained by the experts.

Some existing enterprise process management systems for exception management are also based on a knowledge base. The knowledge base is a repository of knowledge articles that include supporting knowledge associated with the processes in the enterprise. The knowledge base may be maintained by the experts. The knowledge base facilitates enterprise-wide knowledge sharing of articles that include supporting knowledge of the processes in the enterprise

However, approaches used by the enterprise process management systems for exception management, as described above suffer from a few drawbacks. The reasoning technique described in the enterprise process management systems described above exists mostly for enterprises with hardware environments, where the exceptions are static and predictable. The reasoning technique, including the case base, is complex to build for enterprises that include complex processes, such as IT and business processes. The enterprise process management systems for such enterprises are based on the knowledge base only.

Further, the enterprise process management systems based on the case base are generally expensive and sub-optimal with a plurality of constraints. These systems focus primarily on tracking an exception in the enterprise from time of occurrence of the exception till an action is taken to resolve the exception. Further, investigation of the exception and the action that is taken for resolving the exception is a manual process. The rule base of the enterprise process management systems is based on simple rules that are unusable in complex environments of the enterprises that include IT and business processes. Furthermore, the knowledge base is required to be handled by the experts. The enterprise process management systems are dependent on experts, i.e., people who are skilled in the processes, for managing the knowledge base and the rule base. As a result, the experts may need to work for excessive hours for resolving the exceptions. Further, a quality of the articles and the cases is difficult to control and maintain when the users, such as the experts, in the enterprise are responsible for managing and building the repository of articles and the repository of cases.

Based on the foregoing, there is a need for a method and a system for advising end users in an enterprise regarding managing processes in the enterprise. Further, the method and the system should eliminate requirement of experts in the enterprise, thereby resulting in an economical solution for the enterprise. Furthermore, the method and the system should facilitate usage of past experience and knowledge of the end users in the enterprise.

Still further, there is a need for a method and a system that can assist end users to handle exceptions that occur in complex processes of an enterprise. Moreover, there is need for a method and a system that reduces manual work of the end users and automates managing operations in the enterprise. Further, there is need for a method and a system for maintaining a quality associated with knowledge and past experience of the end users in an enterprise.

### SUMMARY OF THE INVENTION

In view of the foregoing disadvantages inherent in the prior art, the general purpose of the present invention is to provision for assisting users in managing operations in an enterprise, that is configured to include all advantages of the prior art, and to overcome the drawbacks inherent therein.

Accordingly, an object of the present invention is to assist users in managing operations in an enterprise.

Another object of the present invention is to reduce a user's involvement in maintaining past experience and knowledge of an enterprise.

Yet another object of the present invention is to utilize a hybrid approach involving at least one case base, at least one knowledge base and at least one rule base for assisting users in managing operations in an enterprise.

Still another object of the present invention is to reduce manual work performed by users in an enterprise for resolving exceptions occurring in the enterprise.

In an aspect of the present invention, a method is provided to assist users in managing operations in an enterprise. The method includes receiving an input from a user in the enterprise. The input is associated with an exception in an operation in the enterprise. The exception indicates occurrence of a fault in the operation. Further, the method includes searching at least one case base based on the input. The at least one case base includes a set of cases. Each case of the set of cases includes an exception and a corresponding resolution. The resolution indicates an action to resolve the exception. Each case of the set of cases is associated with an operation in the enterprise. Furthermore, the method includes displaying at least one case of the set of cases to the user based on the searching of the at least one case base. The at least one case assists the user in managing the operation by offering at least one resolution of the at least one case to resolve the fault in the operation.

The method also includes searching at least one of at least one knowledge base and at least one rule base based on the input. The at least one knowledge base includes a set of knowledge articles and the at least one rule base includes a set of rules, thereby using a hybrid approach to assist the users in managing the operations in the enterprise.

The method also includes automatically executing an action indicated in the resolution of a rule selected from the at least one rule base, thereby reducing the manual work performed by the users in the enterprise.

In another aspect of the present invention, a system is provided for assisting users in managing operations in an enterprise. The system includes a transceiver module configured to receive an input from a user in the enterprise. The input is associated with an exception in an operation in the enterprise. The exception indicates occurrence of a fault in the operation. The system further includes a case management module configured to search at least one case base based on the input. The at least one case base includes a set of cases. Each case of the set of cases includes an exception and a corresponding resolution. The resolution indicates an action to resolve the exception. Each case of the set of cases is associated with an operation in the enterprise. Further, a user interface module is configured to display at least one case of the set of cases to the user based on the search by the case management module in the at least one case base. The at least one case assists the user in managing the operation by offering at least one resolution of the at least one case to resolve the fault in the operation.

In yet another aspect of the present invention a computer program product is embodied on a computer readable medium for assisting users for managing operations in an enterprise. The computer program product includes a program module. The program module includes a set of instructions for receiving an input from a user in the enterprise. The input is associated with an exception in an operation in the enterprise. The exception indicates occurrence of a fault in the operation. Further, the program module includes a set of instructions for searching at least one case base based on the input. The at least one case base includes a set of cases. Each case of the set of cases includes an exception and a corresponding resolution. The resolution indicates an action to resolve the exception. Each case of the set of cases is associated with an operation in the enterprise. Furthermore, the program module includes a set of instructions for displaying at least one case of the set of cases to the user based on the searching of the at least one case base. The at least one case assists the user in managing the operation by offering at least one resolution of the at least one case to resolve the fault in the operation.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a schematic diagram of an environment in which various embodiments of the present invention may be practiced;

FIG. 2 depicts an architectural diagram of a knowledge base, in accordance with an exemplary embodiment of the present invention;

FIG. 3 depicts an architectural diagram of a case base, in accordance with an exemplary embodiment of the present invention;

FIGS. 4A and 4B illustrate a structure of a case in a case base, in accordance with an exemplary embodiment of the present invention;

FIG. 5 depicts a block diagram of a system for assisting users in managing operations in an enterprise, in accordance with an exemplary embodiment of the present invention;

FIG. 6 is a flow diagram representing a method for assisting users in managing operations in an enterprise, in accordance with an embodiment of the present invention; and

FIG. 7 is a flow diagram representing a method for assisting users in managing operations in an enterprise, in accordance with another embodiment of the present invention.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

A method for assisting users in managing operations in an enterprise is provided. The method includes receiving an input from a user in the enterprise. The input is associated with an exception in an operation in the enterprise. The exception indicates occurrence of a fault in the operation. An example of the exception includes but limited to internet server not functioning. Further, the method includes searching at least one case base based on the input. The at least one case base includes a set of cases. Each case of the set of cases includes an exception and a corresponding resolution. The resolution indicates an action to resolve the exception. An example of the resolution includes restarting the internet server. Each case of the set of cases is associated with an operation in the enterprise. Furthermore, the method includes displaying at least one case of the set of cases to the user based on the searching of the at least one case base. The at least one case assists the user in managing the operation by offering at least one resolution of the at least one case to resolve the fault in the operation.

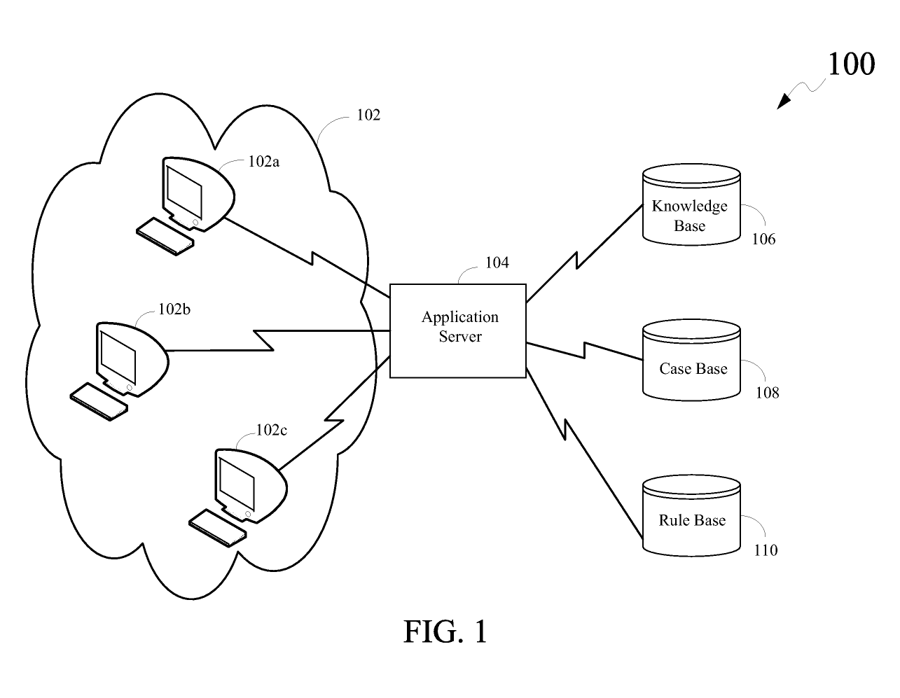

FIG. 1 depicts a schematic diagram of an environment 100 in which various embodiments of the present invention may be practiced. The environment 100 includes an enterprise 102, an application server 104, at least one knowledge base, such as a knowledge base 106; at least one case base, such as a case base 108; and at least one rule base, such as a rule base 110.

The enterprise 102 is an organization that exists for commercial purposes. Examples of the enterprise 102 include financial institutions, healthcare providers, telecommunication service providers, and the like. Various operations are performed in the enterprise 102 by utilizing various resources in the enterprise 102. Examples of the operations include sales, marketing, finance, Information Technology (IT), business, and the like. Examples of the resources include human resources, IT resources, and the like.

The enterprise 102 utilizes resources, such as, a plurality of user terminals, and users that operate the plurality of user terminals for performing the operations. As depicted in FIG. 1, the plurality of user terminals include a user terminal 102a, a user terminal 102b and a user terminal 102c. Examples of the plurality of user terminals may include, but are not limited to, a notebook computer, a personal computer, a mobile, a Personal digital Assistant (PDA), and the like. It will be apparent to a person skilled in the art that the plurality of user terminals in the enterprise 102 may be greater or fewer than depicted in FIG. 1. Further, the environment 100 may include more enterprises with similar features, functionalities and components as the enterprise 102.

As depicted in FIG. 1, the plurality of user terminals is communicably coupled to the application server 104. Examples of coupling between a user terminal of the plurality of user terminals, such as the user terminal 102b, and the application server 104 may include a Wide Area Network (WAN), a Local Area Network (LAN), Internet, intranet, a Virtual Private Network (VPN), wireless networks, and the like. The plurality of user terminals is configured to enable the users in the enterprise 102 to access the application server 104 for managing the operations in the enterprise 102.

The operations in the enterprise 102 need to be managed due to occurrence of exceptions in the operations. An exception is a deviation from a standard procedure of an operation in the enterprise 102. An example of the exception may include “Java Data Base Connection (JDBC) pool connection is lost due to a database failure”. A user in the enterprise 102 may access the application server 104 for managing the exceptions in the operations through a user terminal of the plurality of user terminals, such as the user terminal 102a. A web browser application program is deployed on the user terminal 102a to enable the user to access the application server 104. Examples of the web browser application program may include Internet Explorer, Netscape navigator, Mozilla, and the like.

The application server 104 deploys a web-based application that is accessible to the users in the enterprise 102. The web-based application may be implemented using a web-based programming language, such as, Java Server Pages (JSP), Active Server Pages (ASP), Java Server Faces (JSF), portal technology, and the like. An example of the web-based application includes an enterprise process system. The enterprise process system is capable of assisting the users in the enterprise 102 in managing the operations in the enterprise 102. Each user in the enterprise 102 is associated with identification information that uniquely identifies each user in the enterprise 102. The users may access the web-based application based on the identification information. Examples of the identification information may include user ID, password, and the like.

Further, the web-based application is capable of accessing the at least one knowledge base, such as the knowledge base 106; the at least one case base, such as the case base 108; and the at least one rule base, such as the rule base 110 through an accessing mechanism. Examples of the accessing mechanism may include Internet, intranet, VPNs, LANs, WANs, wireless networks, and the like. The at least one knowledge base, the at least one case base and the at least one rule base include information related to the operations in the enterprise 102. It will be apparent to a person skilled in the art that the knowledge base 106, the case base 108 and the rule base 110 are shown for exemplary purposes and the environment 100 may include greater number of knowledge bases, case bases and rule bases. Further, each of the at least one knowledge base, each of the at least one case base and each of the at least one rule base may be associated with a knowledge base identifier (ID), a case base ID and a rule base ID, respectively. The knowledge base ID, the case base ID and the rule base ID uniquely identify each of the at least one knowledge base, each of the at least one case base and each of the at least one rule base, respectively.

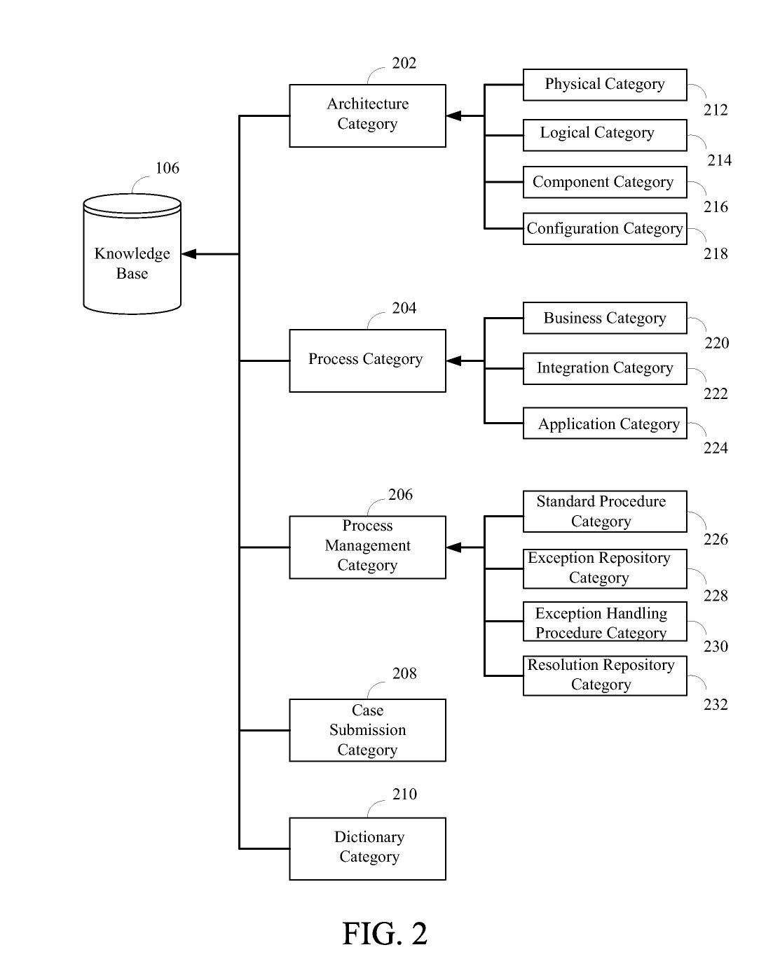

Further, the at least one knowledge base, the at least one case base and the at least one rule base are maintained by a third party provider. Furthermore, the at least one knowledge base, the at least one case base and the at least one rule base may include information related to operations in one or more enterprises. Accordingly, the at least one knowledge base, the at least one case base and the at least one rule base may be accessible to users of the one or more enterprises. It will be apparent to a person skilled in the art that the at least one knowledge base, the at least one case base and the at least one rule base may be implemented as a database, a file base, a distributed system, and the like. Further, the case base 108, the knowledge base 106 and the rule base 110 (as depicted in FIG. 1) depict a logical representation of the at least one case base, the at least one knowledge base and the at least one rule base, respectively, and the physical configuration may vary based on the implementation. The at least one knowledge base, the at least one case base and the at least one rule base are described in more detail in FIGS. 2, 3 and 4.

FIG. 2 depicts an architectural diagram of at least one knowledge base, such as the knowledge base 106 (as described in FIG. 1), in accordance with an exemplary embodiment of the present invention. For the purpose of description of FIG. 2, reference will be made to FIG. 1 described above. The knowledge base 106 includes a set of knowledge articles. Each knowledge article of the set of knowledge articles includes information related to one of managing an environment of an operation, and one or more exceptions and corresponding resolutions. As described previously in conjunction with FIG. 1, an exception of the one or more exceptions may be defined as a deviation from a standard procedure of an operation in an enterprise, such as the enterprise 102. Further, a resolution indicates an action to resolve the exception. An example of the exception may include breakage of a connection between an application program and a server. A corresponding resolution for the exception may include restarting the server.

Alternatively, the information related to managing the environment of the operation may be used by a user in managing the one or more exceptions occurring in the operation. For example, a knowledge article may include information related to configuring software in a particular operation. The user may utilize the information related to configuring the software to resolve the one or more exceptions that the user may encounter while configuring the software.

The information related to the one or more exceptions and the corresponding resolutions support users in managing an operation in the enterprise 102. Accordingly, each knowledge article of the set of knowledge articles is associated with supporting an operation in the enterprise. Further, each knowledge article of the set of knowledge articles is associated with a category based on the operations in the enterprise 102. Furthermore, each knowledge article of the set of knowledge articles may be associated with an article ID that uniquely identifies each knowledge article of the set of knowledge articles. Furthermore, the category of the each knowledge article of the set of knowledge articles is associated with a category ID.

As depicted in FIG. 2, the knowledge base 106 is categorized into an architecture category 202, a process category 204, a process management category 206, a case submission category 208 and a dictionary category 210.

The architecture category 202 includes knowledge articles of the set of knowledge articles that are associated with architecture-based aspects of the operations in the enterprise 102. The knowledge articles associated with the architecture-based aspects of the operations will hereinafter be referred to as ‘architecture-based knowledge articles’.

As is depicted in FIG. 2, the architecture category 202 is categorized into a physical category 212, a logical category 214, a component category 216 and a configuration category 218. Accordingly, the architecture-based knowledge articles may be associated with one of the physical category 212, the logical category 214, the component category 216 and the configuration category 218. The physical category 212 may include architecture-based knowledge articles related to physical server boxes, physical network boxes, and the like. Similarly, the logical category 214 may include architecture-based knowledge articles related to servers, interaction between a server and a router, and the like. The component category 216 may include architecture-based knowledge articles that are associated with hardware, software and firmware components. For example, the component category 216 may include architecture-based knowledge articles related to hardware components, such as, servers, adapters, and the like. The configuration category 218 may include architecture-based knowledge articles related to configuration information of the hardware and the software components.

The process category 204 includes knowledge articles of the set of knowledge articles that are associated with process-based aspects of the operations in the enterprise 102. The knowledge articles associated with the process-based aspects of the operations will hereinafter be referred to as ‘process-based knowledge articles’.

The process category 204 is categorized into a business category 220, an integration category 222 and an application category 224. The process-based knowledge articles may be associated with one of the business category 220, the integration category 222 and the application category 224. An example of a process-based knowledge article associated with the business category 220 may be an Order-to-Cash (OTC) process that describes a business from creating an order through invoice to payment. The OTC process may have integration and application details associated with it. For example, the OTC process may include Order Management (OM) process as an application process and Electronic Data Interchange (EDI) process as an integration process. A knowledge article related to the EDI process will be associated with the integration category 222. A knowledge article related to the OM process will be associated with the application category 224.

Similarly, the process management category 206 includes knowledge articles of the set of knowledge articles that are associated with process management-based aspects of the operations in the enterprise 102. The knowledge articles associated with the process management-based aspects of the operations will hereinafter be referred to as ‘process management-based knowledge articles’. The case submission category 208 includes knowledge articles that relate to case submission by the users in the enterprise 102. More specifically, the case submission category 208 includes candidate cases that have been submitted by users. Each case of the candidate cases is associated with an exception and a resolution.

The process management category 206 is categorized into a standard procedure category 226, an exception repository category 228, an exception handling procedure category 230 and a resolution repository category 232. Each process management-based knowledge article may be categorized into one of the standard procedure category 226, the exception repository category 228, the exception handling procedure category 230 and the resolution repository category 232. The standard procedure category 226 may include process management-based knowledge articles that include information related to standard procedures in the operations in the enterprise 102. Examples of the process management-based knowledge articles that may be categorized into the standard procedure category 226 may include articles on backup and recovery procedures, maintenance preparation, system monitoring, repository data clean up, deleting and archiving, and the like.

The exception repository category 228 may include process management-based knowledge articles that include information related to exceptions occurring in the operations in the enterprise 102. Each knowledge article in the exception repository category 228 relates to description of one exception. Further, the exception repository category 228 may also include a list of the exceptions occurring in the operations in the enterprise 102. The exception handling procedure category 230 may include process management-based knowledge articles that include information related to procedures for handling the exceptions occurring in the operations in the enterprise 102.

The resolution repository category 232 may include process management-based knowledge articles that include information related to resolutions for the exceptions that occur in the operations in the enterprise 102. Each knowledge article in the resolution repository category 232 relates to description of one resolution for an exception. Further, the resolution repository category 232 may also include a list of the resolutions in the enterprise 102.

The dictionary category 210 includes a list of keywords that may be used for searching knowledge articles of the set of knowledge articles.

It will be apparent to a person skilled in the art that, the at least one knowledge base, such as the knowledge base 106 may reside at a single physical location in the form of a database. Alternatively, the at least one knowledge base may be a distributed system, a file system, and the like. Further, each knowledge base of the at least one knowledge base, such as the knowledge base 106, may be associated with a knowledge base ID for uniquely identifying the each knowledge base. Each knowledge article of the set of knowledge articles in the at least one knowledge base may be associated with a title and a subject. The title of a knowledge article indicates an operation associated with the knowledge article. The subject of a knowledge article includes a short description of the knowledge article. Further, each knowledge article of the set of knowledge articles may be associated with a status ID. The status ID of a knowledge article indicates whether the knowledge article has been created, submitted or approved. Status associated with the status ID may include, “New”, “Submitted” or “Live” if the knowledge article has been created, submitted or approved, respectively.

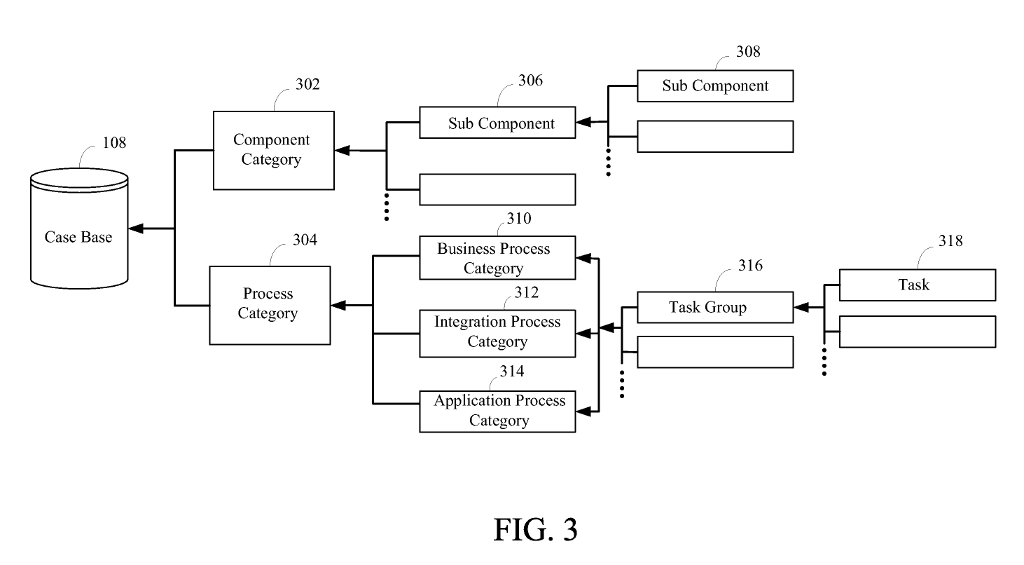

FIG. 3 depicts an architectural diagram of at least one case base, such as the case base 108 depicted in FIG. 1, in accordance with an exemplary embodiment of the present invention. For the purpose of description of FIG. 3, reference will be made to FIG. 1 described above.

The case base 108 includes a set of cases. Each case of the set of cases includes an exception and a corresponding resolution. As described previously in conjunction with FIG. 1, an exception of the one or more exceptions is defined as a deviation from standard procedure in an operation in an enterprise, such as the enterprise 102 explained in FIG. 1. Further, a resolution indicates an action to resolve the exception. For example, an exception “Server not responding” may occur in an operation. The resolution for the same may be “Restart the server.”

The exception and the corresponding resolution of each case of the set of cases may support users in managing operations in the enterprise 102. Accordingly, each case of the set of cases is associated with an operation in the enterprise 102. Further, each case of the set of cases may be associated with a category, based on the operation in the enterprise 102. Furthermore, each case of the set of cases may be associated with a case identifier (ID) that uniquely identifies each case of the set of cases. Furthermore, the category of each case of the set of cases is associated with a category ID. Still further, each case of the set of cases is associated with a status ID. The status ID of a case indicates whether the case has been created, submitted or approved. Status associated with the status ID may include, “Created”, “Submitted” or “Approved” if the case has been created, submitted or approved, respectively.

As depicted in FIG. 3, the case base 108 is categorized into a component category 302 and a process category 304. The component category 302 may include cases that are associated with exceptions occurring in components involved in the operations in the enterprise 102. The cases associated with the exceptions occurring in the components involved in the operations will hereinafter be referred to as ‘component-based cases.’ The component-based cases may be associated with software components, hardware components or firmware components. Examples of the components may include software modules, adapters, integration servers, brokers, Structured Query Language (SQL) Server, and the like.

Similarly, the process category 304 may include cases that are associated with exceptions occurring in processes involved in the operations in the enterprise 102. The cases associated with the exceptions occurring in the processes involved in the operations will hereinafter be referred to as ‘process-based cases.’ Examples of the processes may include order, invoice, ship notice, wire payment, and the like.

As depicted in FIG. 3, the component category 302 is categorized into a first plurality of sub-components, such as a sub-component 306. An example of a sub-component for a component ‘server’ may include thread, scheduler, data store, and the like. Similarly, a subcomponent of the first plurality of sub-components, such as the sub-component 306, may be categorized into a second plurality of sub-components that includes the sub-component 308. It will be obvious to a person skilled in the art that each sub-component of the first plurality of sub components, such as the sub-component 306 may include the second plurality of sub-components, such as the sub component 308.

The process category 304 is categorized into a business process category 310, an integration process category 312 and an application process category 314. The business process category 310 may include process-based cases that are associated with exceptions occurring in business processes involved in the operations. The process-based cases associated with the exceptions occurring in the business processes involved in the operations will hereinafter be referred to as ‘business process-based cases.’ Examples of the business processes may include management processes, operational processes, supporting processes, and the like.

The integration process category 312 may include process-based cases that are associated with exceptions occurring in integration processes involved in the operations. The process-based cases associated with the exceptions occurring in the integration processes involved in the operations will hereinafter be referred to as ‘integration process-based cases.’

The application process category 314 may include process-based cases that are associated with exceptions occurring in application processes involved in the operations. The process-based cases associated with the exceptions occurring in the application processes involved in the operations will hereinafter be referred to as ‘application process-based cases.’ An example of an application process is OM in Enterprise Resource Planning (ERP).

As depicted in FIG. 3, the business process category 310, the integration process category 312 and the application process category 314 are associated with a plurality of task-groups that includes a task-group 316. Examples of the task-group 316 for a business process ‘invoice’ may include web service, Electronic Data Interchange (EDI) translation, JDBC, and the like. Each of the plurality of the task-groups, such as the task-group 316 includes a plurality of tasks that includes a task 318. Examples of the task 318 for a business process ‘invoice’ may include back-end interaction operations, translation operations, routing operations, and the like.

As described previously in conjunction with FIG. 1, the at least one case base, such as the case base 108 may reside at a single physical location in the form of a database. Alternatively, the at least one case base may be a distributed system, a file system, and the like. Further, each of the at least one case base, such as the case base 108, may be associated with the case base ID. Furthermore, each case of the set of cases in the at least one case base may be associated with a title, a summary, a source and a problem description. The title of each case of the set of cases indicates an exception included in each case of the set of cases. The summary of each case of the set of cases summarizes the exception included in each case of the set of cases. The source of each case of the set of cases indicates an area in an operation where the exception included in each case of the set of cases occurs. The problem description of each case of the set of cases describes the exception included in each case of the set of cases.

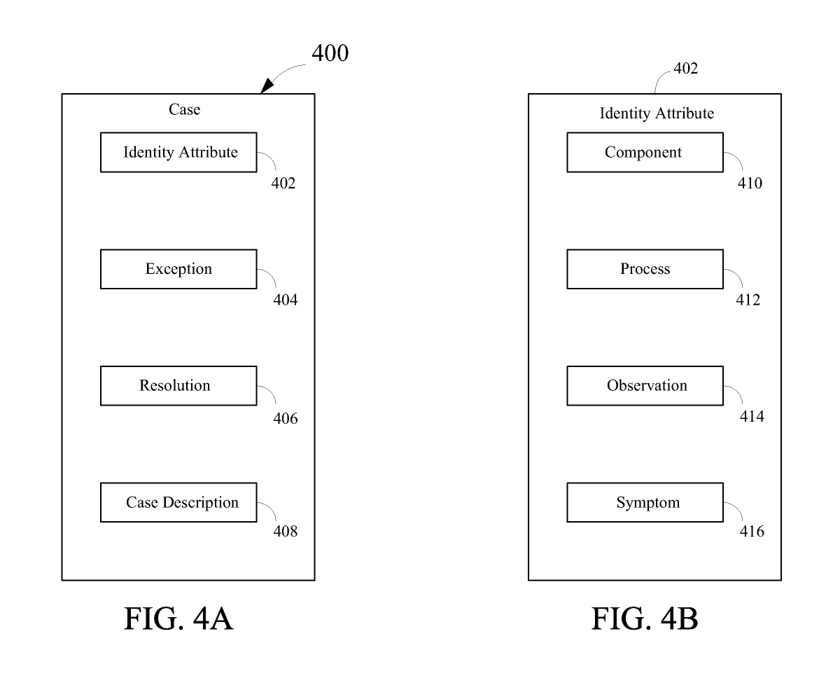

FIGS. 4A and 4B illustrate a structure of a case 400 in at least one case base, such as the case base 108 depicted in FIG. 1, in accordance with an exemplary embodiment of the present invention. For the purpose of description of FIGS. 4A and 4B, reference will be made to FIGS. 1-3 described above. As mentioned in conjunction with FIG. 3, the at least one case base, such as the case base 108 includes the set of cases. Each case of the set of cases is structured as depicted by the case 400 in FIG. 4A. The case 400 includes an identity attribute 402, an exception 404, a resolution 406 and a case description 408. FIG. 4B illustrates the identity attribute 402 of the case 400 in detail.

As depicted in FIG. 4B, the identity attribute 402 includes a component 410, a process 412, an observation 414 and a symptom 416.

The component 410 of the identity attribute 402 indicates an architectural area of an occurrence of the exception 404 of the case 400. More specifically, the architectural area includes a path representing component from the component category 302 and sub-components, such as the sub-component 306, the sub-component 308, and the like, as explained in conjunction with FIG. 3. For example, if an exception occurs in a sub-component ‘thread’ of a sub-component ‘server’ of the component category 302, the path of the architectural area may be represented as Server.Thread.

The process 412 of the identity attribute 402 defines a procedural area of the occurrence of the exception 404 of the case 400. The procedural area may be associated with one of the business process category 310, the integration process category 312 and the application process category 314. More specifically, the procedural area includes a path representing a process from one of the business process category 310, the integration process category 312 and the application process category 314. Further, the procedural area may include a task-group, such as the task-group 316 and a task, such as the task 318, as explained in conjunction with FIG. 3. For example, if an exception occurs in a task-group ‘back-end interaction operations’ of an invoice process that belongs to the business process category, the path of the procedural area may be represented as Business.Invoice.Backend_Interactions.

The observation 414 of the identity attribute 402 uniquely identifies each case. The observation 414 includes at least one question-answer pair for uniquely identifying the each case. An example of the observation may include a question of a first question-answer pair as “INTG.IS.Administrator: IS admin page problem?” and an answer of the first question-answer pair as “Frozen”. A question of a second question-answer pair may be “INTG.IS.Administartor: IS Admin page problem?” and an answer of the second question-answer pair may be “Not Responding.”

In one embodiment of the present invention, the observation 414 may be associated with an observation ID, a name and a value. The observation ID represents a unique identifier identifying each case of the set of cases. The name represents questions of the at least one question-answer pair. Further, the value represents answers of the at least one question-answer pair.

The symptom 416 of the identity attribute 402 includes one or more key phrases. Each key phrase of the one or more key phrases includes a set of keywords associated with the exception 404 of the case 400. For example, for an exception “Server is not responding”, the symptom 416 may include “Server not responding” and “Server is frozen” as the one or more key phrases.

The exception 404 of the case 400 (depicted in FIG. 4A) represents a fault that may occur in an operation, such as “Server not responding”. The exception 404 belongs to the list of exceptions in the exception repository category 228 of the knowledge base 106, as explained in conjunction with in FIG. 2.

The resolution 406 of the case 400 represents an action to resolve the exception 404 that may occur in an operation. An example of the resolution 406 for the exception “Server not responding” is “Restart the server.” The resolution 406 belongs to the list of resolutions in the resolution repository category 232, as explained in conjunction with the knowledge base 106 in FIG. 2.

The case description 408 of the case 400 represents meta data associated with each case of the set of cases. The meta data includes information associated with the case 400. Examples of the meta data include at least one of a title, a summary, a source, a problem description and a case type, as explained in conjunction with FIG. 3. As explained previously, the title of the case 400 indicates an exception included in the case 400. The summary of the case 400 summarizes the exception included in the case 400. The source of the case 400 indicates an area in an operation where the exception 404 of the case 400 occurs. The problem description of the case 400 describes the exception 404.

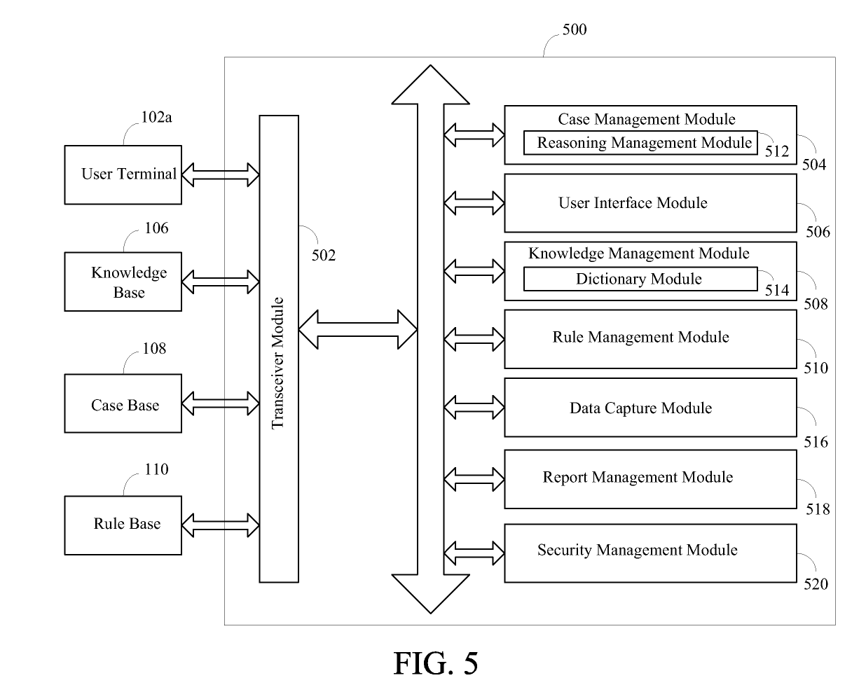

It will be apparent to a person skilled in the art that the structure of the case 400 as explained in FIG. 4 may include other information associated with the case 400, such as a case ID, a category ID, and the like. The set of cases of the at least one case base, the set of knowledge articles of the at least one knowledge base and the set of rules of the at least one rule base assist users in an enterprise, such as the enterprise 102, to manage operations in the enterprise. A system for assisting the users in managing the operations in the enterprise is described in detail in FIG. 5.

FIG. 5 depicts a block diagram of a system 500 for assisting users in managing operations in an enterprise, such as the enterprise 102, in accordance with an embodiment of the present invention. Further, the block diagram includes the user terminal 102a, the knowledge base 106, the case base 108 and the rule base 110, as described in FIG. 2. For the purpose of description of FIG. 2, reference will be made to components of the environment 100 described in FIG. 1. The system 500 includes a transceiver module 502, a case management module 504, a user interface module 506, a knowledge management module 508, a rule management module 510, a reasoning management module 512, a dictionary module 514, a data capture module 516, a report management module 518 and a security management module 520.

The transceiver module 502 is configured to receive an input from a user in the enterprise. The input is associated with an exception in an operation in the enterprise. The exception indicates an occurrence of a fault in the operation. The case management module 504 is configured to search at least one case base based on the input received by the transceiver module 502. The at least one case base includes a set of cases. Each case of the set of cases includes an exception and a corresponding resolution. The resolution indicates an action to resolve the exception. Each case of the set of cases is associated with an operation in the enterprise.

The user interface module 506 is configured to display at least one case of the set of cases to the user based on the search by the case management module 504 on the at least one case base. Each case of the at least one case includes a resolution for the exception in the operation, thereby assisting the user in managing the operation in the enterprise.

As described previously, the users may encounter various exceptions while performing the operations in the enterprise. A user may access the system 500 through a user terminal, such as the user terminal 102a, for resolving an exception in an operation in the enterprise. The users may be one of end users in the enterprise and administrators. It will be apparent to a person skilled in the art that the user terminal 102a is shown for exemplary purposes. Further, the user can interact with the system 500 only through a user terminal. The system 500 is capable of accessing at least one of the at least one case base, the at least one knowledge base and the at least one rule base. The at least one case base, such as the case base 108 includes a set of cases, as described in FIGS. 3 and 4. The at least one case base provides a repository of past experience and knowledge of the users in the enterprise in the form of the set of cases. Each case of the set of cases includes an exception and a corresponding resolution. The resolution indicates an action to resolve the exception. Each case of the set of cases is associated with an operation in the enterprise.

The at least one knowledge base, such as the knowledge base 106 includes a set of knowledge articles, as described in FIG. 2. The at least one knowledge base provides a repository of past experience and knowledge of the users in the enterprise in the form of the set of knowledge articles. Each knowledge articles of the set of knowledge articles includes information related to one of managing an environment of an operation, and one or more exceptions and corresponding resolutions. The each knowledge article is associated with supporting an operation in the enterprise. Similarly, the at least one rule base, such as the rule base 110 includes a set of rules. The at least one rule base provides a repository of past experience and knowledge of the users in the enterprise in the form of the set of rules. Each rule of the set of rules includes an exception and a resolution. Each rule of the set of rules is associated with an operation in the enterprise.

The at least one case base, the at least one knowledge base and the at least one rule base may be accessed by the end users in the enterprise, through the system 500, for managing the operations in the enterprise. Further, the at least one case base, the at least one knowledge base and the at least one rule base may be accessed by the administrators for maintenance purposes. The system 500 is capable of providing a user interface to the user on the user terminal 102a, through the user interface module 506. The user interface module 506 is configured to provide a menu on the user terminal 102a for the user. The menu enables the user to select one of the at least one knowledge base, the at least one case base and the at least one rule base for managing the operation. The user may provide a selection of one of the at least one knowledge base, the at least one case base and the at least one rule base to the system 500 through the user terminal 102a. Further, the user may provide an input to the system 500. The input is associated with the exception in the operation in the enterprise.

The transceiver module 502 of the system 500 receives the input from the user in the enterprise based on the selection of one of the at least one case base, the at least one knowledge base and the at least one rule base. The case management module 504 handles the input received by the transceiver module 502, when the selection of the user indicates the at least one case base. When the user selects the at least one case base, the input may include at least one of the component category 302, the process category 304, the observation 414, the identity attribute 402, the symptom 416, the exception 404, the resolution 406, a date range and a result limit.

For the purpose of this description, the component category 302, the process category 304, the observation 414, the identity attribute 402, the symptom 416, the exception 404 and the resolution 406 will be as previously defined in conjunction with FIGS. 3 and 4. The date range indicates a time period within which the set of cases being searched should fall. The result limit indicates number of cases to be searched by the case management module 504.

The case management module 504 is configured to search the at least one case base based on the input. In one embodiment, the case management module 504 may include a case finder module (not shown). The case finder module may be configured to generate a query based on the input for searching the at least one case base. For example, the user may want to search cases related to a server component, in an invoice process, including the observation “Can you start the server?—No”, with the date range between 15 May 2007 and 15 May 2008 and the result limit as 20 results. The case finder module will create a query based on the input. The query may be transmitted to the at least one case base by the transceiver module 502. The transceiver module 502 may receive at least one case from the at least one case base. The case finder module is configured to obtain the at least one case from the transceiver module 502.

Each case of the at least one case includes a resolution for the exception in the operation in the enterprise. The case finder module may be configured to transmit the at least one case to the user interface module 506. The user interface module 506 may be configured to display the at least one case to the user based on the search by the case finder module of the case management module 504 on the at least one case base.

In another embodiment of the present invention, the case management module 504 includes a reasoning management module 512. The reasoning management module 512 is configured to rank the at least one case in an order of relevance based on the input. More specifically, the reasoning management module 512 is configured to rank each case of the at least one case based on similarity of the each case of the at least one case with the input received from the user. Further, the case management module 504 may be configured to transmit the at least one case to the user interface module 506 for displaying the at least one case to the user on the user terminal 102a, based on the search by the case management module 504.

The user may provide a selection of a resolution included in a case of the at least one case to the case management module 504 through the user terminal 102a. Further, the user interface module 506 may be configured to display the action indicated in the resolution of a case of the at least one case to the user. The user may perform the action indicated in the resolution of the case manually.

Further, the case management module 504 is configured to create a case based on the input received from the user. For example, when an end user encounters an exception in an operation, he might search the at least one case base for an existing case. If the user cannot find the case, he might trouble-shoot the exception himself based on his knowledge and knowledge from a knowledge article of at least one knowledge base. Once the user finds a resolution and resolves the exception, the user may create a candidate case using the case management module 504. For the same purpose, the user may provide information associated with the candidate case, such as, title, summary, problem description, lessons, reference, an exception, a resolution, a symptom, an observation, and the like. The transceiver module 502 may be configured to receive the input for adding the candidate case from the user. The case management module 504 may add the candidate case to the case submission category 208 explained in FIG. 2.

Further, the case management module 504 is configured to enable the user to browse through the set of cases in the case base 108 based on the input received from the user. The user may browse through the set of cases through a user interface. The user interface module 506 is configured to display the user interface that includes categories of the set of cases, and sub-categories of the categories. The user may be enabled to browse using the categories and the sub-categories to locate cases specific to a particular operation.

In one embodiment of the present invention, the knowledge management module 508 of the system 500 handles the at least one knowledge base, such as the knowledge base 106. The knowledge management module 508 handles the input received by the transceiver module 502, when the selection of the user indicates the at least one knowledge base. When the user selects the at least one knowledge base, the input may include information related to knowledge articles, such as, a category, keywords, the date range, the result limit, and the like. For the purpose of this description, the category will be as defined in conjunction with FIG. 2.

The knowledge management module 508 is communicably coupled to the transceiver module 502 to receive the input from the user. The knowledge management module 508 is configured to search the at least one knowledge base, such as the knowledge base 106, based on the input from the user. In one embodiment, the knowledge management module 508 may include an article finder module (not shown).

The article finder module may be configured to generate a query based on the input for searching the at least one knowledge base. For example, the user may want to search a knowledge article on back-up and recovery procedures. The user may provide the input as, the process management category 206, along with keywords such as “backup” and “recovery”, and search related information, such as full text search or title search, with the date range between 3 Dec. 2007 and 12 Feb. 2008 and the result limit as 15 results. The article finder module will create a query based on the input. The query may be transmitted to the at least one knowledge base by the transceiver module 502. The transceiver module 502 may receive at least one knowledge article from the at least one knowledge base. The article finder module is configured to obtain the at least one knowledge article from the transceiver module 502.

Each knowledge article of the at least one knowledge article includes information related to one of managing an environment of an operation, and one or more exceptions and corresponding resolutions for the operation in the enterprise. In one embodiment, the information related to managing the environment of the operation may be used by a user in managing the one or more exceptions occurring in the operation. The article finder module may be configured to transmit the at least one knowledge article to the user interface module 506. The user interface module 506 may be configured to display the at least one knowledge article to the user based on the search by the article finder module of the knowledge management module 508.

In one embodiment, the knowledge management module 508 also includes the dictionary module 514. The dictionary module 514 is capable of extracting the list of keywords from the dictionary category 210 of the knowledge base 106, as described in FIG. 2. Further, the dictionary module 514 is configured to enable the user to select a keyword from the list of keywords.

In another embodiment, the knowledge management module 508 is configured to rank the at least one knowledge article in an order of relevance. More specifically, the knowledge management module 508 is configured to rank each knowledge article of the at least one knowledge article based on frequency and occurrence of the keywords provided by the user in the each knowledge article.

Further, the knowledge management module 508 is configured to create a knowledge article based on the input received from the user. For example, the user may want to add a knowledge article to the at least one knowledge base. For the same purpose, the user may provide information associated with the knowledge article, such as, the category, title, enterprise name, text of the knowledge article, status of the knowledge article, language, and the like. The transceiver module 502 may be configured to receive the input for adding the knowledge article from the user. The knowledge management module 508 may create a knowledge article in the at least one knowledge base, based on the information associated with the knowledge article. Further, the knowledge management module 508 is configured to enable the user to browse through the set of knowledge articles in the knowledge base 106 based on the input received from the user. The user may browse through the set of knowledge articles through a user interface. The user interface module 506 is configured to display the user interface that includes categories of the set of knowledge articles, and sub-categories of the categories. The user may be enabled to browse using the categories and the sub-categories to locate knowledge articles specific to a particular operation.

Furthermore, the knowledge management module 508 is configured to enable the user to add a new category for categorizing the set of knowledge articles. The user may provide information associated with the category, such as name of the category, description of the category, status of the category, and the like. The category may be added to categories described in conjunction with FIG. 2.

In one embodiment of the present invention, the input received from the user by the transceiver module 502 may be an exception. The rule management module 510 of the system 500 is configured to handle the exception by searching the at least one rule base, such as the rule base 110, for a resolution to resolve the exception. For example, the user may provide the input in form of an exception as “Server not responding.” The rule management module 510 is configured to select a rule of the set of rules from the at least one rule base, based on the input. Further, the rule management module 510 is configured to automatically execute an action indicated in the resolution of the selected rule. Alternatively, the rule management module 510 may be configured to provide an option to the user through the user interface module 506. The user may select options to indicate consent for automatic or manual execution of the action indicated in the resolution of the rule selected from the at least one rule base.

The user may be enabled by the system 500 to add cases and knowledge articles to the at least one case base and the at least one knowledge base, respectively. The data capture module 516 of the system 500 is configured to check the input received by the transceiver module 502. Further, the data capture module 516 is configured to capture the input received from the user by the transceiver module 502. The input may include one of a case, a knowledge article and an exception. The data capture module 516 is communicably coupled to the rule management module 510. When the input is an exception, the data capture module 516 is configured to transmit the exception to the rule management module 510 for searching the exception in the rule base 110. Further, the data capture module 516 is communicably coupled to the case management module 504. When the input is a candidate case, the data capture module 516 is configured to transmit the candidate case to the case management module 504 for adding the candidate case to the set of cases in the at least one case base. The candidate case is associated with a status ID “Submitted”. Further, the candidate case may be added to the set of cases once the status ID associated with the case represents “Approved”. The candidate cases may be retrieved from the case submission category 208. Furthermore, the data capture module 516 is communicably coupled to the knowledge management module 508. When the input is a knowledge article, the data capture module 516 is configured to transmit the knowledge article to the knowledge management module 508 for adding the knowledge article to the set of knowledge articles in the at least one knowledge base. The knowledge article is associated with a status ID “Submitted”. Further, the knowledge article may be added to the set of cases once the status ID associated with the knowledge article represents “Live”.

The at least one case base, the at least one rule base and the at least one knowledge base are accessed by the users through user terminals, such as the user terminal 102a, for managing the operations in the enterprise. The at least one case base, the at least one rule base and the at least one knowledge base may also be accessed by administrators, such as knowledge engineers, for maintaining the at least one case base, the at least one rule base and the at least one knowledge base. The administrators may access the system 500 through a user terminal, such as the user terminal 102a.

The case management module 504 is configured to enable an administrator to create a new component for categorizing the set of cases. The administrator may provide information associated with the component, such as name of the component, description of the component, and the like. For example, the administrator may add a new component ‘server’ and the description of the component ‘server’.

Further, the case management module 504 is configured to enable the administrator to create a new observation for a new question-answer pair that the user may encounter. The administrator may provide information associated with the observation, such as, name of the observation, value, and the like. For example, the name of the observation may be “INTG.IS.Administrator: IS Admin page problem” and values of the observation may include “Frozen” or “Not Respond”.

Still further, the case management module 504 is configured to enable the administrator to approve a case added by a user. The case management module 504 is also configured to enable the administrator to modify and delete cases from the set of cases.

For the purpose of maintenance of the at least one knowledge base, the knowledge management module 508 is configured to enable the administrator to approve a knowledge article added by a user. Further, the knowledge management module 504 is configured to enable the administrator to modify and delete knowledge articles from the set of knowledge articles. Furthermore, the knowledge management module 508 may be configured to enable the administrator to add resolutions to the resolution repository category 232 and exceptions to the exception repository category 228.

For the purpose of management of the at least one rule base, the rule management module 510 is configured to enable the administrator to add a rule to the set of rules. More specifically, the rule management module 510 may include a resolution module (not shown). The resolution module is configured to enable the administrator to associate an exception of the exception repository category 228 with a resolution of the resolution repository category 232 to create a rule. Further, the rule management module 510 is configured to enable the administrator to modify and delete rules from the set of rules.

The dictionary module 514 is configured to enable the administrator to maintain the dictionary category 210 of the knowledge base 106, as described in FIG. 2. More specifically, the dictionary module 514 enables the administrator to add a keyword to the list of keywords in the dictionary category 210.

The report management module 518 of the system 500 is configured to generate a report for a pre-defined time period. The report includes information related to the set of cases in the at least one case base. The information related to the set of cases may include number of new cases, number of matched cases, and the like. The pre-defined time period may be provided by the administrator. The report management module 518 is communicably coupled to the transceiver module 502 for transmitting the report to the administrator.

The security management module 520 of the system 500 is configured to manage access to the at least one case base by the user based on a set of access privileges. The set of access privileges is associated with the user. Further, the security management module 520 may also be configured to manage access to the at least one knowledge base and the at least one rule base by the user. The set of access privileges may be defined as functionalities of the system 500 that are accessible to a user, such as a user in the enterprise, the administrator, and the like. Furthermore, the security management module 520 may be configured to access identification information of the users in the enterprise. Identification information uniquely identifies a user in the enterprise. Examples of the identification information include user ID, password, and the like. The identification information of each user may be associated with the set of access privileges of the user. The security management module 520 is communicably coupled to the user interface module 506 of the system 500. The security management module 520 is configured to determine the set of access privileges of the users, based on the identification information of the users. The user interface module 506 is further configured to display a user interface to the user for accessing the at least one case base based on the set of access privileges associated with the user.

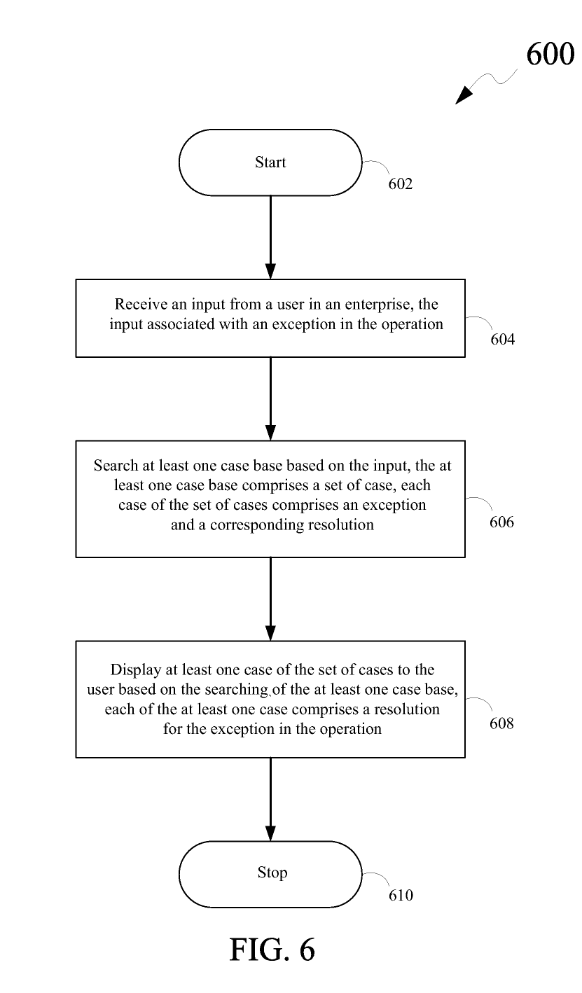

It will be apparent to a person skilled in the art that the components described in FIG. 5, such as the transceiver module 502, the case management module 504, the user interface module 506, the knowledge management module 508, the rule management module 510, the reasoning management module 512, the dictionary module 514, the report management module 518, the security management module 520, the resolution module, the case finder module and the article finder module may be implemented as hardware modules, software modules, firmware modules, or any combination thereof. Furthermore, it will be evident to those skilled in the art that the system 500 may include a microprocessor, a battery unit and an input/output (I/O) interface for performing typical functions of a server. The system 500 is used for assisting the users in managing the operations in the enterprise. A method for assisting the users in managing the operations in the enterprise is described in FIG. 6.

FIG. 6 is a flow diagram representing a method 600 for assisting users in managing operations in an enterprise, such as the enterprise 102 described in FIG. 1, in accordance with an embodiment of the present invention. For the purpose of description of FIG. 6, reference will be made to the description of FIGS. 1-5. Further, at least one case base may be same as described in conjunction with FIGS. 3 and 4.

The method 600 begins at 602. At 602, a user who encounters an exception in operation in the enterprise provides an input to a system, such as the system 500, through a user terminal, such as the user terminal 102b. At 604, the system receives the input from the user in the enterprise. The input is associated with the exception in the operation. The exception indicates occurrence of a fault in the operation. The input may include at least one of a category and one or more keywords. The category is an identification related to the operation. Further, the one or more keywords are associated with the operation.

The input may include at least one of the exception 404, the resolution 406, the component 410, the process 412, the observation 414, the symptom 416, a date range and a result limit.

The component 410 indicates an architectural area of the enterprise where the exception has occurred. Examples of the architectural area include integration server, broker, JDBC adapter, Oracle Enterprise Resource Planning (ERP), SQL server, and the like. The process 412 indicates a procedural area of the enterprise where the exception has occurred. Examples of the process include order, invoice, ship notice, wire payment, and the like. The observation 414 is at least one question-answer pair that uniquely defines a case of the set of cases within the component 410 and the process 412. Examples of questions of the at least one question answer pair include, “Can you start the server?”, “Can you find an error in the error log?”, and the like. The date range indicates a time period within which the at least one case searched from the at least one case base should fall. The result limit indicates number of result cases required by the user.

At 606, at least one case base, such as the case base 108, is searched based on the input. The at least one case base includes a set of cases. Each case of the set of cases includes an exception and a corresponding resolution. The resolution indicates an action to resolve the exception. Each case of the set of cases is associated with an operation in the enterprise. For example, a case may include the at least one question-answer pair associated with a sales operation, such as an invoice process.

At 608, at least one case of the set of cases is displayed to the user based on the searching of the at least one case base. For example, when the input is associated with an invoice operation, the at least one case displayed to the user includes at least one resolution for resolving an exception in the invoice operation. Each case of the at least one case includes a resolution for the exception in the operation, thereby assisting the user in managing the operation in the enterprise. The at least one case displayed to the user may also include other information associated with the at least one case, such as , a case ID, a category ID, a title, a summary, a source, a problem description, and the like. At 610, the user may utilize the action indicated in the at least one resolution of the at least one case to resolve the exception in the operation. For example, for an exception “Server not responding”, a resolution of the at least one resolution may indicate “Restart the server”. The user may restart the server to resolve the exception. Further, the user may resolve the exception manually, or provide consent to automatically resolve the exception by utilizing a resolution.

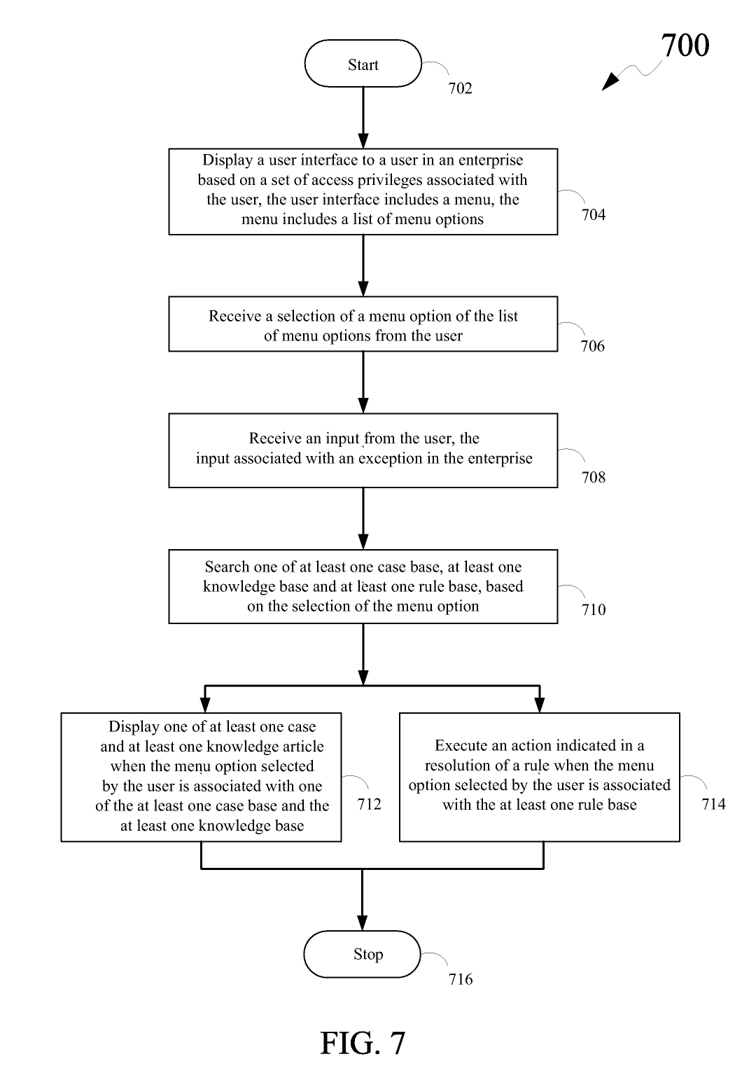

The user is one of an administrator managing the at least one case base and an end-user in the enterprise. A detailed flow diagram that depicts a method for assisting the users in managing the operations in the enterprise is explained in FIG. 7.

FIG. 7 is a flow diagram representing a method 700 for assisting users in managing operations in an enterprise, such as the enterprise 102 as described in FIG. 1, in accordance with another embodiment of the present invention. For the purpose of description of FIG. 7, reference will be made to the detailed description of FIGS. 1-6.

The method 700 begins at 702. A user in the enterprise may perform various operations. Examples of the enterprise include financial institutions, telecommunication service providers, healthcare institutions, and the like. Examples of the operations in the enterprise include business, IT, marketing, sales, finance, and the like. A user may encounter an exception while performing an operation in the enterprise. As explained previously, an exception indicates occurrence of a fault in the operation. An example of an exception is “Connection with the database is broken”. The user may need to resolve the exception before proceeding with the operation.

The user may resolve the exception by accepting assistance from a system, such as the system 500 described in FIG. 5. The user may access the system through a user terminal, such as the user terminal 102a, explained in conjunction with FIGS. 1 and 5. The user may be capable of accessing at least one knowledge base, such as the knowledge base 106; at least one case base, such as the case base 108; and at least one rule base, such as the rule base 110, through the system. For the same purpose, identification information is received from the user by the system. As explained previously, the identification information is associated with each user who accesses the system. Further, the identification information uniquely identifies each user. Examples of the identification information include a user ID, password, and the like. For the purpose of description of FIG. 7, the at least one case base, the at least one knowledge base and the at least one rule base may be same as described in FIGS. 2, 3 and 4.

The identification information of each user is associated with a set of access privileges. The set of access privileges may be defined as functionalities of the system that are accessible to the user. The user may be one of an end-user in the enterprise and an administrator managing the system. Access to the at least one knowledge base, the at least one case base and at least one rule base by the user is managed based on the set of access privileges associated with the user.

At 704, a user interface is displayed to the user on the user terminal, based on the set of access privileges associated with the user. The user interface includes a menu. The menu includes a list of menu options accessible to the user, based on the set of access privileges associated with the user. The user may access at least one of the at least one knowledge base, the at least one case base and at least one rule base by selecting a menu option of the list of menu options.

At 706, a selection of the menu option is received from the user. The list of menu options for an end-user in the enterprise may enable the end-user to search the at least one case base, add a case to the at least one case base, search the at least one knowledge base, add a knowledge article to the at least one knowledge base, and resolve an exception by utilizing a rule in the at least one rule base. The list of menu options for an administrator may enable the administrator to add, modify and delete a case of the at least one case base; add, modify and delete a knowledge article of the at least one knowledge base; add, modify and delete a rule of the at least one rule base; approve one of a case and a knowledge article added by the user; associate an exception with a resolution to form a rule; create new categories in one of the at least one knowledge base and the at least one case base; generate reports associated with the set of cases in the at least one case base; add new exceptions to the list of exceptions in the at least one knowledge base; and add new resolutions to the list of resolutions in the at least one knowledge base. It will be apparent to a person skilled in the art that the list of menu options may include other menu options for the end-user and the administrator, apart from the aforementioned menu options.

At 708, an input is received from the user based on the menu option selected by the user. The menu option selected by the user indicates one of the at least one case base, the at least one knowledge base and the at least one rule base selected by the user. Further, the input received from the user is associated with an exception in the enterprise. As described previously, the exception indicates occurrence of a fault in an operation in the enterprise. An example of an exception may include “Integration server not responding.”

The input received from the user may include at least one of the component category 302, the process category 304, the identity attribute 402, the exception 404, the resolution 406, a date range and a result limit when the selection of the menu option indicates the at least one case base. For the purpose of this description, the component category 302, the process category 304, the identity attribute 402, the exception 404, the resolution 406, the date range and the result limit will be as described in conjunction with FIGS. 3, 4 and 5. For example, the input may include a ‘server’ as the component category 302, an invoice process as the process category 304, “Can you start the server?—No” as the at least one question-answer pair of the observation 414, “Server not booting” as the one or more key phrases of the symptom 416, the date range between 15 May 2007 and 15 May 2008 and the result limit as 20 results.

For receiving the input from the user, the user interface displayed to the user may enable the user to provide the input. The user interface may display drop-down boxes, selection boxes, and the like, to enable the user to select the input, such as the component category 302, the process category 304, and the like.

In one embodiment of the present invention, the input received from the user may include information related to knowledge articles, such as a category, keywords, the date range, the result limit, and the like, when the selection of the menu option indicates the at least one knowledge base. For the purpose of this description, the category will be same as defined in FIG. 2. The user may provide the input as, the process management category 206, along with keywords such as “backup” and “recovery”, and search related information, such as full text search or title search, with the date range between 3 Dec. 2007 and 12 Feb. 2008 and the result limit as 15 results.

Further, the input, such as, the category, the keywords, and the like may be selected by the user through the user interface. The user interface may display a list of keywords to the user for selecting the input. The list of keywords may be extracted from the dictionary category 210 of the at least one knowledge base, such as the knowledge base 106, as explained in FIGS. 2 and 5.

In yet another embodiment of the present invention, the input received from the user may be an exception. For example, the user may provide the input as “Server not responding”. The input may be selected by the user through the user interface. The user interface may display drop- down boxes, selection boxes, and the like, to enable the user to select the input.

At 710, the at least one case base, the at least one knowledge base and the at least one rule base is searched, based on the selection of the menu option and the input received from the user. In one embodiment, a query may be generated by the system, based on the input and the selection of the menu option.

In one embodiment of the present invention, the method 700 may include creating a query to search the at least one case base when the selection of the menu option indicates searching the at least one case base. Further, the method 700 may include transmitting the query to the at least one case base. At least one case of the set of cases searched may be received in response to the query transmitted to the at least one case base. Each case of the at least one case includes a resolution to resolve the exception in the operation in the enterprise.

In another embodiment of the present invention, the method 700 may include creating a query to search the at least one knowledge base when the selection of the menu option indicates searching the at least one knowledge base. Further the method 700 may include transmitting the query to the at least one knowledge base. At least one knowledge article of the set of knowledge articles searched may be received in response to the query transmitted to the at least one knowledge base. Each knowledge article of the at least one knowledge article includes information related to one of managing an environment of an operation, and one or more exceptions and corresponding resolutions for the operation in the enterprise. More specifically, the information related to managing the environment of the operation may be used by a user in managing the one or more exceptions occurring in the operation.

In yet another embodiment of the present invention, the method 700 may include creating a query to search the at least one rule base when the selection of the menu option indicates searching the at least one rule base. Further, the method 700 may include transmitting the query to the at least one rule base. The rule base is searched for a resolution to resolve the exception received as input from the user. A rule of the set of rules may be selected from the at least one rule base by the system based on.

At 712, one of the at least one case and the at least one knowledge article is displayed to the user when the menu option selected by the user is associated with one of the at least one case base and the at least one knowledge base. The displaying of the at least one case and the at least one knowledge article may include transmitting one of the at least one case and the at least one knowledge article to the user on a user terminal, such as the user terminal 102a.

The at least one case is displayed to the user based on the searching of the at least one case base. The at least one case displayed to the user may include a case ID, category ID, a case base ID, and the like. In one embodiment, the at least one case may be ranked in an order of relevance based on the input prior to displaying the at least one case to the user. Each case of the at least one case may be ranked based on similarity of each case of the at least one case with the input received from the user. More specifically, an identity attribute of each case of the at least one case is compared with values of an identity attribute received from the user, such as the component 410, the observation 414 and the symptom 416. The order of relevance associates a relevance with each case of the at least one case. Further, the order of relevance may indicate a most relevant case of the at least one case.

The method 700 may include receiving a selection of a resolution included in a case of the at least one case from the user. Further, the method 700 may include performing an action indicated in the resolution selected by the user. Alternatively, the user may be enabled to manually perform the action indicated in the resolution of the case. The user may select the resolution based on the relevance associated with the case. For example, the user may select a resolution of the most relevant case of the at least one case.

In another embodiment of the present invention, the at least one knowledge article is displayed to the user based on searching the at least one knowledge base. The at least one knowledge article displayed to the user may include a knowledge base ID, an article ID, a category ID, a title, a status ID, a subject; and the like. Further, the at least one knowledge article may be ranked in an order of relevance based on the input prior to displaying the at least one knowledge article to the user. Each knowledge article of the at least one knowledge article may be ranked based on frequency of occurrence of the input in each knowledge article of the at least one knowledge article. The order of relevance associates a relevance with each knowledge article of the at least one knowledge article. Further, the order of relevance may indicate a most relevant knowledge article of the at least one knowledge article.

At 714, an action indicated in a resolution of the rule selected from the at least one rule base is executed. In one embodiment, the method 700 includes displaying an option to the user on the user interface for selecting one of an automatic and a manual execution of the action indicated in the resolution of the selected rule. The user may be enabled to select an option to indicate consent for executing the action automatically. Alternatively, the user may manually execute the action.

Further, the method 700 may include creating a case based on the input received from the user and the selection of the menu option. For example, the user may want to add a case to the at least one case base. For the same purpose, the user may provide information associated with a case, such as, title, summary, problem description, lessons, reference, an exception, a resolution, symptoms, observations, and the like. The method 700 may include receiving the information associated with the case from the user and creating the case, based on the information associated with the case.

In one embodiment, the method 700 includes displaying the user interface to the user to enable the user to browse through the set of cases of the at least one case base based on the input. The user may browse through the set of cases through a user interface. The user interface includes categories of the set of cases, and sub-categories of the categories. The user may be enabled to browse using the categories and the sub-categories to locate cases specific to a particular operation.

Similarly, the method 700 may include creating a knowledge article based on the input received from the user and the selection of the menu option. For example, the user may to add a knowledge article to the at least one knowledge base by providing information associated with the knowledge article, such as, the category, title, enterprise name, text of the knowledge article, language, and the like. The method 700 may include receiving the information associated with the knowledge article from the user and creating the knowledge article based on the information associated with the knowledge article. The status ID of the knowledge article may represent “Live” when the user is creating the knowledge article. Further, the status ID of the knowledge article may represent “Submitted” when the user submits the knowledge article.

In one embodiment, the method 700 includes displaying the user interface to the user to enable the user to browse through the set of knowledge articles of the at least one knowledge base based on the input. The user may browse through the set of knowledge articles through a user interface. The user interface includes categories of the set of knowledge articles, and sub-categories of the categories. The user may be enabled to browse using the categories and the sub-categories to locate knowledge articles specific to a particular operation.

In another embodiment, the method 700 may include adding a new category for categorizing the set of knowledge articles. The user may be enabled by the user interface to add the new category. Further, the method may include receiving information associated with the new category, such as name of the category, description of the category, status of the category, and the like from the user.

In yet another embodiment of the present invention, the method 700 includes checking the input received from the user. Further, the method 700 includes capturing at least one of a case, a knowledge article and an exception based on the input. The method 700 includes checking the input in the at least one rule base when the input is an exception. Further, the method 700 includes transmitting the input to the at least one case base when the input is the case. Alternatively, the method 700 includes transmitting the input to the at least one knowledge base when the input is the knowledge article. Furthermore, the method 700 includes adding the input to the at least one case base when the input is the case. Alternatively, the method includes adding the input to the at least one knowledge base when the input is the knowledge article.

For the purpose of maintaining the at least one case base, the at least one knowledge base and the at least one rule base, the user, such as an administrator may be enabled to select menu options of the list of menu options, based on the set of access privileges associated with the administrator.

For the purpose of managing the at least one case base, the method 700 may include creating a new component for categorizing the set of cases. For creating the new component, the method 700 may include receiving information associated with the component, such as name of the component, description of the component, and the like.

Further, the method 700 may include creating a new observation for a new question-answer pair that the user may encounter. The method 700 may include receiving information associated with the observation, such as, name of the observation, value, and the like.

Still further, the method 700 may include displaying a user interface to the administrator for approving a case added by a user in the enterprise. The method 700 may also include displaying a user interface to the administrator for enabling the administrator to modify and delete cases from the set of cases.

For the purpose of maintaining the at least one knowledge base, the method 700 may include displaying a user interface to the administrator for approving a knowledge article added by a user in the enterprise. The method 700 may also include displaying a user interface to the administrator for enabling the administrator to modify and delete knowledge articles from the set of knowledge articles. Furthermore, the method 700 may also include displaying a user interface to the administrator for adding resolutions to the resolution repository category 232 and exceptions to the exception repository category 228.

For the purpose of maintaining the at least one rule base, the method 700 may include displaying a user interface to the administrator for adding a rule to the set of rules. More specifically, adding the rule may include creating a rule by the administrator. The method of creating the rule may include associating an exception in the exception repository category 228 with a resolution in the resolution repository category 232. Further, the method 700 may include displaying a user interface to the administrator to enable the administrator to modify and delete rules from the set of rules.

For the purpose of maintaining the dictionary category 210 of the at least one knowledge base, the method 700 includes displaying a user interface to enable the administrator to add a keyword to the list of keywords in the dictionary category 210. The method 700 further includes receiving a keyword from the administrator. Furthermore, the method 700 includes adding the keyword to the dictionary category 210 of the at least one knowledge base.

For the purpose of maintaining a record of the set of cases in the at least one case base, the method 700 includes generating a report for a pre-defined time period. The report includes information related to the set of cases in the at least one case base. The information related to the set of cases may include number of new cases, number of matched cases, and the like. The pre-defined time period may be provided by the administrator. Further, the method 700 includes transmitting the report to the administrator. The administrator may be a client manager for an enterprise, such as the enterprise 102. The report may provide information to the administrator regarding time spent by a team of sub-administrators (who work under the administrator) to resolve the new cases in the enterprise.

For the purpose of managing access to one of the at least one case base, the at least one knowledge base and the at least one rule base by the user, the set of access privileges is associated with each user, as described previously. For the same purpose, the method 700 includes managing access to the at least one case base, the at least one knowledge base and the at least one rule base, based on the set of access privileges. The set of access privileges may be defined as functionalities of the system that are accessible to a user, such as a user in the enterprise, an administrator, and the like. Furthermore, the method 700 includes accessing identification information of the users in the enterprise. The identification information uniquely identifies a user in the enterprise. Examples of the identification information include user ID, password, and the like. Still further, the method 700 includes determining the set of access privileges of the users based on the identification information of the users. Further, the method 700 includes displaying a user interface to the user for accessing one of the at least one case base, the at least one knowledge base and the at least one rule base, based on the set of access privileges associated with the user.

At 716, the method 700 ends. It will be apparent to a person skilled in the art that the list of menu options described in FIG. 7 are for exemplary purposes and the method 700 may include greater or fewer menu options than those described in FIG. 7. Further, extensions of the list of menu options may also be present in other embodiments of the method 700.

Assisting users in managing operations in an enterprise by a system, such as the system 500 of the present invention, is advantageous for providing the users access to past experience and knowledge of the enterprise for resolving exceptions in the operations in the enterprise. The past experience and knowledge of the operations in the enterprise is accessible to the users through a hybrid approach that includes at least one of at least one knowledge base, at least one case base and at least one rule base. Further, the system reduces the users' involvement in maintaining and managing the past experience and knowledge of the operations. Furthermore, the system assists in decreasing a turnaround time for resolving the exceptions that occur in the operations in the enterprise. In turn, the productivity of the enterprise increases. Still further, the system assists in reducing manual work by the users for resolving the exceptions. The system provides options for automatically resolving the exceptions that occur in the operations.

As described above, the embodiments of the present invention may be embodied in the form of a computer program product for assisting users in managing operations in an enterprise. Embodiments of the present invention may also be embodied in the form of program module containing a set of instructions embodied in tangible media, such as floppy diskettes, CD-ROMs, hard drives, or any other computer-readable storage medium, wherein, when the program module is loaded into and executed by a computer, the computer becomes an apparatus for practicing the present invention. It will be apparent to a person skilled in the art that the present invention as described above, may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present invention. When implemented on a general-purpose microprocessor, the computer program code segments configure the microprocessor to create specific logic circuits.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present invention.

What is claimed is:

1. A method for assisting users in managing operations in an enterprise, the method comprising:
receiving an input from a user in the enterprise, the input associated with an exception in an operation in the enterprise, the exception indicating occurrence of a fault in the operation;
searching at least one case base based on the input, the at least one case base comprising a set of cases, each case of the set of cases comprising an exception and a corresponding resolution, the resolution indicating an action to resolve the exception, each case of the set of cases associated with an operation in the enterprise; and
displaying at least one case of the set of cases to the user based on the searching of the at least one case base,
wherein the at least one case assists the user in managing the operation by offering at least one resolution of the at least one case to resolve the fault in the operation.

2. The method of claim 1, wherein each case of the set of cases further comprises:
a case description representing meta data about the each case; and
an identity attribute comprising:
a component indicating an architectural area of an occurrence of the exception;
a process indicating a procedural area of the occurrence of the exception;
an observation uniquely identifying the each case, the observation comprising at least one question-answer pair for uniquely identifying the each case; and
a symptom comprising one or more key phrases, each of the one or more key phrases comprising a set of keywords, the set of keywords associated with the exception.

3. The method of claim 1, wherein the input comprises at least one of
a category, wherein the category is an identification related to the operation; and
one or more keywords, wherein the one or more keywords are associated with the operation.

4. The method of claim 1 further comprising ranking the at least one case in an order of relevance based on the input prior to displaying the at least one case to the user.

5. The method of claim 1 further comprising performing the action indicated in the resolution of a case of the at least one case.

6. The method of claim 1 further comprising managing access to the at least one case base by the user based on a set of access privileges, the set of access privileges associated with the user.

7. The method of claim 6 further comprising displaying a user interface to the user for accessing the at least one case base based on the set of access privileges associated with the user.

8. The method of claim 1 further comprising generating a report for a pre-defined time period, the report comprising information related to the set of cases of the at least one case base.

9. The method of claim 1 further comprising searching at least one knowledge base based on the input, the at least one knowledge base comprising a set of knowledge articles.

10. The method of claim 9 further comprising capturing the input received from the user, the input comprising one of a case, a knowledge article and an exception.

11. The method of claim 9, wherein each knowledge article of the set of knowledge articles is associated with supporting an operation in the enterprise, and each knowledge article of the set of knowledge articles comprises information related to one of managing an environment of the operation, and one or more exceptions and corresponding resolutions.

12. The method of claim 9 further comprising displaying at least one knowledge article of the set of knowledge articles to the user based on the searching of the at least one knowledge base.

13. The method of claim 1 further comprising:
searching at least one rule base based on the input, the at least one rule base comprising a set of rules, each rule of the set of rules comprising an exception and a resolution, the each rule of the set of rules associated with an operation in the enterprise;
selecting a rule of the set of rules from the at least one rule base based on the input; and
automatically executing an action indicated in the resolution of the selected rule.

14. The method of claim 1 wherein the user is one of an administrator and an end user.

15. A system for assisting users in managing operations in an enterprise, the system comprising:
a transceiver module configured to receive an input from a user in the enterprise, the input associated with an exception in an operation in the enterprise, the exception indicating occurrence of a fault in the operation;
a case management module configured to search at least one case base based on the input, the at least one case base comprising a set of cases, each case of the set of cases comprising an exception and a corresponding resolution, the resolution indicating an action to resolve the exception, each case of the set of cases associated with an operation in the enterprise; and
a user interface module configured to display at least one case of the set of cases to the user based on the search by the case management module in the at least one case base,
wherein the at least one case assists the user in managing the operation by offering at least one resolution of the at least one case to resolve the fault in the operation.

16. The system of claim 15, wherein the case management module further comprises a reasoning module configured to rank the at least one case in an order of relevance based on the input.

17. The system of claim 15, wherein the user interface module is further configured to display the action indicated in the resolution of a case of the at least one case to the user.

18. The system of claim 15 further comprising a security management module configured to manage access to the at least one case base by the user based on a set of access privileges, the set of access privileges associated with the user.

19. The system of claim 18, wherein the user interface module is further configured to display a user interface to the user for accessing the at least one case base based on the set of access privileges associated with the user.

20. The system of claim 15 further comprising a report management module configured to generate a report for a pre-defined time period, the report comprising information related to the set of cases of the at least one case base.

21. The system of claim 15 further comprising a knowledge management module configured to search at least one knowledge base based on the input, the at least one knowledge base comprising a set of knowledge articles.

22. The system of claim 21 further comprising a data capture module configured to capture the input received from the user, the input comprising one of a case, a knowledge article and an exception.

23. The system of claim 21, wherein the user interface module is configured to display at least one knowledge article of the set of knowledge articles to the user based on the searching of the at least one knowledge base by the knowledge management module.

24. The system of claim 15 further comprising a rule management module configured to perform at least one of
search at least one rule base based on the input, the at least one rule base comprising a set of rules, each rule of the set of rules comprising an exception and a corresponding resolution;
select a rule of the set of rules from the at least one rule base based on the input; and
automatically execute an action indicated in the resolution of the selected rule.

25. A computer program product embodied on a computer readable medium for assisting users for managing operations in an enterprise, the computer program product comprising a program module, the program module comprising:
a set of instructions for receiving an input from a user in the enterprise, the input associated with an exception in an operation in the enterprise, the exception indicating occurrence of a fault in the operation;
a set of instructions for searching at least one case base based on the input, the at least one case base comprising a set of cases, each case of the set of cases comprising an exception and a corresponding resolution, the resolution indicating an action to resolve the exception, each case of the set of cases associated with an operation in the enterprise; and
a set of instructions for displaying at least one case of the set of cases to the user based on the searching of the at least one case base,
wherein the at least one case assists the user in managing the operation by offering at least one resolution of the at least one case to resolve the fault in the operation.

26. The computer program product according to claim 25, wherein the program module further comprises a set of instructions for ranking the at least one case in an order of relevance based on the input prior to displaying the at least one case to the user.

27. The computer program product according to claim 26, wherein the program module further comprises a set of instructions for performing the action indicated in the resolution of a case of the at least one case.

28. The computer program product according to claim 25, wherein the program module further comprises a set of instructions for managing access to the at least one case base by the user based on a set of access privileges, the set of access privileges associated with the user.

29. The computer program product according to claim 28, wherein the program module further comprises a set of instructions for displaying a user interface to the user for accessing the at least one case base based on the set of access privileges associated with the user.

30. The computer program product according to claim 25, wherein the program module further comprises a set of instructions for generating a report for a pre-defined time period, the report comprising information related to the set of cases of the at least one case base.

31. The computer program product according to claim 25, wherein the program module further comprises a set of instructions for searching at least one knowledge base based on the input, the at least one knowledge base comprising a set of knowledge articles.

32. The computer program product according to claim 31, wherein the program module further comprises a set of instructions for capturing the input received from the user, the input comprising one of a case, a knowledge article and an exception.

33. The computer program product according to claim 31, wherein the program module further comprises a set of instructions for displaying at least one knowledge article of the set of knowledge articles to the user based on the searching of the at least one knowledge base.

34. The computer program product according to claim 25, wherein the program module further comprises:
a set of instructions for searching at least one rule base based on the input, the at least one rule base comprising a set of rules, each rule of the set of rules comprising an exception and a resolution;
a set of instructions for selecting a rule of the set of rules from the at least one rule base based on the input; and
a set of instructions for automatically executing an action indicated in the resolution of the selected rule.
